(19) United States
(12) Patent Application Publication
(10) Pub. No.: US 2026/0335849 A1
(43) Pub. Date: Oct. 29, 2026

(54) WIRELESS SENSING SYSTEM FOR EXTREME AND HARSH ENVIRONMENTS

(71) Applicant: SHELL USA, INC., Houston, TX (US)

(72) Inventors: Jonathan J. BERNSTEIN, Cambridge, MA (US); Anupam CHOUBEY, Cambridge, MA (US); Rebecca J. CHRISTIANSON, Cambridge, MA (US); Robert E. DOE, Cambridge, MA (US); Akram KALATE, Cambridge, MA (US); Michael J. MATRANGA, Beaufort, SC (US); Francis J. SCHLOSSER, Cambridge, MA (US); Robert D. TINGLEY, Cambridge, MA (US); Jacob P. TREADWAY, Cambridge, MA (US)

(21) Appl. No.: 19/485,544

(22) PCT Filed: Jun. 3, 2024
(86) PCT No.: PCT/US2024/032188

§ 371 Date: Nov. 18, 2025

Related U.S. Application Data
(60) Provisional application No. 63/506,992, filed on Jun. 8, 2023.

(51) Int. Cl. B01J 8/00; H04B 1/40; H04W 4/38

(52) U.S. Cl. CPC B01J 8/001; H04B 1/40; H04W 4/38; B01J 2219/00195

(57) ABSTRACT

A system including a vessel having a wall defining a volume. The vessel may contain media. The system also includes a wireless sensing system having a plurality of sensor nodes dispersed within the media and that may measure one or more parameters or conditions within the vessel and wirelessly transmit a first data signal containing the one or more parameters/conditions, and one or more through-wall communications systems attached to the wall of the vessel and that may wirelessly communicate with the plurality of sensor nodes, to transmit a first communication signal, a first power signal, or both through the wall of the vessel, to receive the first data signal, and to transmit a second data signal through the wall of the vessel, and a control system communicatively coupled to the wireless sensing system and that may determine and profile the one or more parameters/conditions based on the second data signal.

### BACKGROUND OF THE DISCLOSURE

The present disclosure generally relates to a wireless sensing system. More specifically, the present disclosure relates to a wireless sensing system for monitoring and profiling conditions within a vessel under extreme or harsh environments.

Monitoring and profiling conditions in an enclosed vessel, such as a reactor, provides useful information for understanding reaction kinetics, catalyst performance, safety parameters, and system efficiency, among others. This information is particularly useful when the environment within the enclosed vessel is extreme or harsh. For example, certain processes take place at sub-ambient or elevated temperatures (e.g., temperatures below 0 degrees Celsius (°C) or above 150 °C), at sub-ambient or elevated pressures (e.g., pressures less than 0.10 megapascals (MPa) and up to 21 MPa), and corrosive conditions. To avoid undesirable process conditions that may impact system performance under these extreme/harsh environments, sensors are used to monitor parameters such as pressure and temperature and provide insight as to the conditions within the enclosed vessel. While sensors used to monitor parameters and conditions in extreme/harsh environments exist, these sensors require a physical connection (e.g., an electrical or pneumatic connection) between the sensor and an external control system. For example, a thermocouple requires a physical connection to an external control system for signal communication that enables monitoring temperature in the harsh environment. Generally, vessels that utilize thermocouples have thermowells that extend through a wall of the vessel to locations at which the temperature is to be measured. However, because the location of the temperature measurement is limited to an area near and around the vessel walls, hot and/or cold spots in other areas of the vessel that are not near the wall may be undetected. Therefore, the temperature at these locations may not be indicative of the temperature throughout the vessel. As such, thermocouples may not provide reliable insight as to what is occurring inside the vessel.

In addition, existing wireless sensors generally use electromagnetic signals to wirelessly communicate with control systems located remotely. However, certain vessels may be manufactured from materials that impede or otherwise attenuate signals. For example, in refineries and chemical plants vessels used as reactors are metallic (e.g., steel). Metallic materials have a shielding effect and are not suitable for effectively passing electromagnetic signals transmitted from a wireless sensor within the vessel to a remote control system and vice versa. Moreover, wireless sensors generally require a power source (e.g., a battery). However, when used in industrial-type vessels, such as a reactor in a refinery or chemical plant, it may not be feasible to replace or charge the power source in the wireless sensors without decommissioning the vessel and removing the wireless sensor.

Moreover, monitoring and profiling parameters/conditions in extreme and/or harsh environments may be challenging due to variety of factors such as, for example, thermal, mechanical, electrical, radioactive, and/or chemical stresses. Doing so wirelessly results in additional challenges. For example, without a wired connection, sensors used in these environments may have a lack of precision and reliability of measurements. Therefore, there continues to be a need for wireless sensors that may be used to monitor and profile conditions within vessels throughout all or a portion of its volume and withstands extreme harsh or environments while providing accurate and reliable measurements. Furthermore, it is advantageous for wireless sensors used in extreme and/or harsh environments to operate independently with little to no maintenance (e.g., battery replacement/recharge) as they may be inaccessible for an extended period of time and not easily replaced (e.g., without shutting down and/or decommissioning the system).

### SUMMARY

In an embodiment, a system including a vessel having a wall defining a volume. The vessel may contain media. The system also includes a wireless sensing system having a plurality of sensor nodes dispersed within the media and that may measure one or more parameters or conditions within the vessel and to wirelessly transmit a first data signal containing the one or more parameters/conditions, and one or more through-wall communications systems attached to the wall of the vessel and that may wirelessly communicate with the plurality of sensor nodes, to transmit a first communication signal, a first power signal, or both through the wall of the vessel, to receive the first data signal, and to transmit a second data signal through the wall of the vessel, and a control system communicatively coupled to the wireless sensing system and that may determine and profile the one or more parameters/conditions based on the second data signal.

In another embodiment, a method for monitoring and profiling conditions within a vessel using a wireless sensing system, including the steps of transmitting a first signal to a through-wall communications systems attached to a wall of the vessel. The through-wall communications system may wirelessly communicate with one or more sensor nodes dispersed with media contained in the vessel. The method also includes transmitting a second signal, wirelessly, from the through-wall communications system in response to the first signal to the one or more sensor nodes. The one or more sensor nodes includes an antenna that may receive the second signal. The method also includes measuring one or more parameters associated with a condition to be profiled in response to the second signal. The sensor node includes a sensor that may measure the one or more parameters in response to the second signal and generated a first data signal. The method also includes transmitting the first data signal containing information associated with the one or more parameters measured, a location of the one or more sensor nodes, or both to the through-wall communications systems. The first data signal is an electromagnetic signal. The method further includes determining and profiling, using a processor, the condition within the vessel based on the first data signal. The processor is part of a control system communicatively coupled to the wireless sensing system.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

Advantages of the disclosure may become apparent upon reading the following detailed description and upon reference to the drawings in which:

FIG. 1 is a schematic diagram of a system that includes a vessel and wireless sensing system that includes a plurality of wireless sensor nodes dispersed within media contained in the vessel and a through-wall communication system, in accordance with an embodiment of the present disclosure;

FIG. 2 is a block diagram of a portion of the vessel of the system of FIG. 1, whereby the through-wall communications system includes an internal module coupled to an interior surface of the vessel and an external module coupled to an exterior surface of the vessel, in accordance with an embodiment of the present disclosure;

FIG. 3 is a block diagram of a sensor node of the wireless sensing system that may be used with the system of FIG. 1, whereby the sensor node includes a sensor and antenna for wirelessly transmitting and receiving electromagnetic signals, in accordance with an embodiment of the present disclosure;

FIG. 4 is a block diagram of an internal module of the wireless sensing system that may be used in the system of FIG. 1, whereby the internal module includes signal and power transducers and frequency converter and amplifier for converting acoustic signals into electromagnetic signals, and an antenna for wirelessly receiving and transmitting electromagnetic signals, in accordance with an embodiment of the present disclosure;

FIG. 5 is a schematic diagram of a portion of the vessel of FIG. 2, whereby the external module includes transducers arranged in an array, in accordance with an embodiment of the present disclosure;

FIG. 6 is a cross sectional view of a portion of the vessel of FIG. 2, whereby the external module includes transducers arranged in a disk-like configuration and each transducer wirelessly transmits an acoustic signal to a single transducer of the internal module, in accordance with an embodiment of the present disclosure; and

FIG. 7 is a flow diagram of a method for monitoring and profiling parameters/conditions using the system of FIG. 1, in accordance with an embodiment of the present disclosure.

### DETAILED DESCRIPTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

Various industrial processes (e.g., refineries, chemical plants, food and beverage industry, among others) use large vessels (e.g., tanks, containers, reactors, and the like) to perform various functions and processes under extreme or harsh environments. As used herein, the term “extreme/harsh environments,” “extreme/harsh conditions,” and the like are intended to denote environments/conditions having sub-ambient to ultra-high (hydrostatic or uniaxial) pressures, sub-ambient to ultra-high temperatures (e.g., less than −40 °C to above 200 °C), one or more physical states (e.g., solid, liquid, gas or combination thereof) which is one or more of the following: corrosive, toxic, radioactive, caustic, reactive, flammable, and oxidizing or reducing. Monitoring system parameters and conditions within these vessels provides a means to understand reaction kinetics, process conditions and efficiencies, as well as mitigate undesirable events that may impact system performance and safety. One technique for monitoring system parameters within vessels, such as those used in refineries and chemical plants, is to use pressure and/or temperature sensors. These sensors, however, generally include cables and other wiring to communicate with external control/data processing systems. In addition, the location(s) at which these sensors are positioned within the vessel are limited. For example, thermocouples used to measure and monitor temperature in vessels are generally disposed along vessel walls or within thermowells disposed in the walls of the vessels. As such, the temperature measurements are localized to an area near and around the walls of the vessel, which may not be indicative of the temperature throughout the vessel (e.g., in areas that are not near vessel walls and location of thermocouples). Therefore, hot and/or cold spots within the vessel may not be detected.

Accordingly, disclosed herein is a wireless self-locating sensing system having wireless sensors that are incorporated into and surrounded by a medium in which chemical reactions and other processes occur. The wireless self-locating sensing system of the present disclosure provides localized data (i.e., measurements) associated with reaction and/or process conditions within a vessel containing the medium during operation. It does so by utilizing multiple signals of different wavelengths and frequencies to provide power and measure conditions within the vessel. For example, the wireless self-locating sensing system may use acoustic range signals (e.g., between 200 Hertz (Hz) and 20 kilohertz (kHz)) and radiofrequency (RF) signals (e.g., between 9 kHz and 300 gigahertz (GHz)) to measure and profile parameters within the vessel wirelessly. As discussed in further detail below, the acoustic range signals are used for wireless communication between external components (located outside of the vessel) and internal components (located within the vessel) of the sensing system, and the RF signals for wireless communication between internal components of the sensing system. The wireless sensor may transmit the RF signals containing data associated with the measured parameters and that are modified/converted into acoustic signals before being wirelessly transmitted across the vessel wall and to the external components of the wireless sensing system. In doing so, the sensor system imposes no spatial or dynamic (motion) constraints in order to operate. In addition, the sensor node or internal module may be located either within or without the media located within the harsh environment. An external base station may use the information from the acoustic signals to monitor and/or profile reaction kinetics, catalyst performance, and safety parameters among other things. The external base station may also trigger the external component of the wireless sensing system of the present disclosure to transmit an acoustic power signal through the vessel wall that is modified/converted into an RF power signal by the internal component. This RF power signal may be used to provide power to one or more of the wireless sensors within the media. The localization techniques described herein surpass traditional multilateration techniques (e.g., angle-of-arrival, time of arrival, time difference of arrival), which can become limited in a moderately reverberant environment since the multilateration metrics are not related to position in the simple geometric sense that systems like GPS are based upon. Disclosed herein is the use of frequency domain amplitude and phase response in conjunction with a calibration model in order to determine sensor position. In addition, some embodiments in which internal communication is achieved at low RF frequencies may localize sensor nodes by using multi-point amplitude of arrival because the strong signal attenuation provides for high accuracy of position (to within an inch) due to strong attenuation of the signal and corresponding effect that it dampens the signals of the relevant modes reflected off the vessel walls. By using the wireless sensing system disclosed herein, conditions within the vessel may be monitored and profiled across the entirety of the vessel, rather than at localized locations at or near the vessel walls.

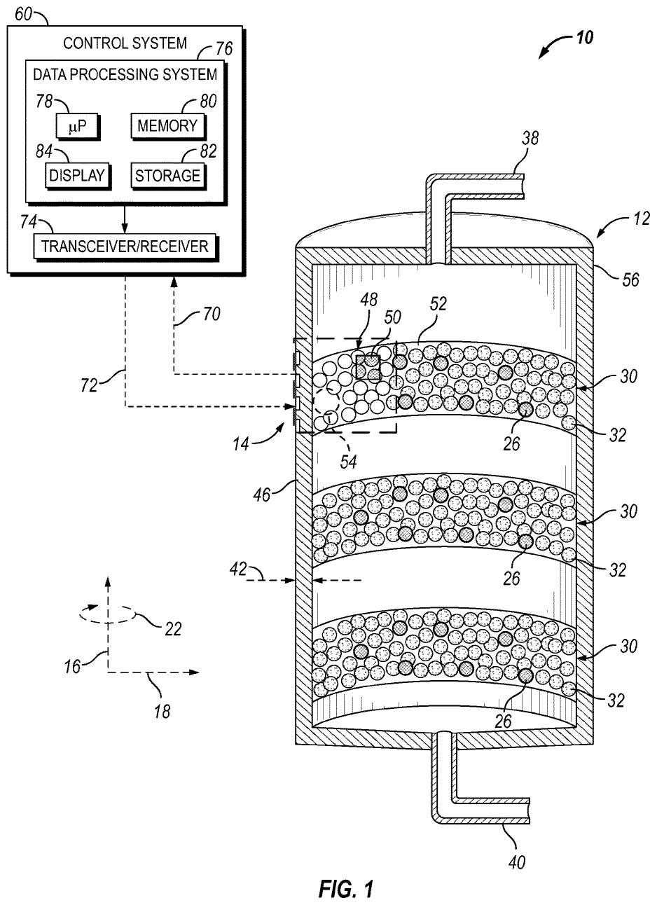

With the foregoing in mind, FIG. 1 is a cross-sectional view of a system 10 having a vessel 12 (e.g., reactor) that includes a wireless sensor system 14, in accordance with an embodiment of the present disclosure. The vessel 12 may have an axial axis or direction 16, a radial axis or direction 18 away from axis 16, and a circumferential axis or direction 22 around the axis 16. The conditions within the vessel 12 may range from sub-ambient to ultra-high (hydrostatic or uniaxial) pressures, sub-ambient to ultra-high temperatures, corrosive, and the environment surrounding the vessel 12 may be terrestrial (e.g., located in a refinery or a chemical plant) or extraterrestrial (e.g., located at a space station, a satellite, or on a space shuttle orbiting space). Due, in part, to the harsh conditions in which the vessel 12 and its contents may be exposed to, it may be beneficial to regularly monitor and profile the conditions within the vessel 12. Gaining insight to the conditions within the vessel 12 may help mitigate adverse events such as, for example, thermal runaway and undesirable pressure buildup, by alerting operators of the system 10. In addition, monitoring and profiling the conditions within the vessel 12 may facilitate understanding reaction kinetics and catalyst performance. However, existing sensors are not robust and hardy to sustain the harsh conditions and provide precise, reliable, and accurate measurements that may be used to profile, monitor, or otherwise gain insight as to what is occurring inside the vessel 12. Moreover, certain sensors may require wired connections to transmit and receive signals containing information of conditions within the vessel and for powering the sensor, respectively. In certain system configurations and media, wired connections are not feasible and limited to placement along walls of the vessel. Therefore, to facilitate monitoring and profiling conditions throughout a volume of the vessel 12, the wireless sensing system 14 includes a plurality of sensor nodes 26 that measure parameters and conditions within the vessel 12 and wireless transmit measured data to other components of the wireless sensor system 14, as discussed in further detail below. The measured parameters/conditions include, but are not limited to, pressure, temperature, chemical composition, vapor and liquid composition, density, flow rate, pH, vibration, radiation, magnetic flux, light intensity, signal attenuation, and sound intensity, among others.

In the illustrated embodiment, the vessel 12 includes multiple catalyst beds 30 (e.g., reaction zones), each having a plurality of catalyst particles 32. The catalyst beds 30 are spaced apart and located at different heights along the axial axis 16 of the vessel 12. In certain embodiments, the vessel 12 has a single catalyst bed 30. As discussed above, the wireless sensing system 14 disclosed herein monitors and profiles conditions throughout the volume of the vessel 12. Accordingly, within each catalyst bed 30, are distributed multiple sensor nodes 26 and surrounded by the catalyst particles 32. In essence, the sensor nodes 26 are mixed in with the media within the vessel 12. In this embodiment, the media includes the catalyst particles 32. Notably, embodiments of the present disclosure will be discussed in the context of a fixed-bed catalyst reactor. However, as should be appreciated, the vessel 12 may be any other suitable vessel such as, for example, moving bed reactor, ebullated bed reactor, grain silo, distillation tank, or any other reactor or container used to contain materials and/or perform processes under harsh conditions (e.g., sub-ambient (e.g., −40 °C) to ultra high temperatures (e.g., above 200 °C) and pressures (e.g., up to 21 MPa), corrosive environments, etc.) in either a terrestrial or extraterrestrial location. Moreover, the present disclosure may also be used in pipelines, aircrafts, vehicles (e.g., automobiles, trains, tractors, etc.), engines, and the like without departing from the scope. In addition, the present disclosure is discussed in the context of catalyst particles as the medium. However, the wireless sensor system 14 may be used in vessels having other media (e.g., gas, liquid, plasma, biological materials, radioactive materials, and/or solid materials).

The catalyst particles 32 may be of any size and shape typically used in industry, including extrudates of any shape (e.g., cylinders, dilobes, trilobes, and quadralobes), spheres, balls, irregular aggregates, pills and powders. The sizes of the catalyst particles 32 may be in the range of from 0.1 mm to 200 mm, and may have any composition. Common compositions of the catalyst particles 32 include an inorganic oxide component, such as, silica, alumina, silica-alumina, and titania. The composition may further include a catalytic metal component, such as any of the transition metals, including chromium, molybdenum, tungsten, rhenium, iron, cobalt, nickel, palladium, platinum, gold, silver, and copper. The concentration of the metal components of the catalyst particles may be upwardly to 60 wt. %, based on metal, regardless of its actual state, and, typically, the metal concentration is in the range of from 0.1 to 30 wt. %, based on metal, regardless of its actual state.

In addition to the catalyst beds 30, the vessel 12 includes other components such as an inlet 38 and an outlet 40 for receiving and outputting fluids, respectively, used, produced, or otherwise contained within the vessel 12. For example, the inlet 38 facilitates introduction of a feed into the vessel 12. Similarly, the outlet 40 facilitates removal of an effluent produced in the catalyst beds 30 containing reaction products. The vessel 12 may include additional features not depicted such as additional flow lines, inlets, outlets, valves, and sensors among other features.

The vessel 12 is definable by a depth and a width. A typical depth of each catalyst bed 30 is in the range of from 0.5 to 20 meters, and a typical effective width of each catalyst bed 30 is in the range of from 0.5 to 20 meters. Therefore, the sensor node 26 may be surrounded (e.g., along the circumferential direction 22) by a layer or envelop of catalyst particles 32 having a thickness upwardly to 20 meters requiring signals received and/or transmitted by the sensor node 26 to pass through a bed thickness of the catalyst particles 32 of from about 0.5 to about 20 meters or more. For example, the entirety or only a portion of the sensor node 26 may be surrounded by the catalyst particles 32. By way of non-limiting example, the sensor node 26 may be 10%, 25%, 50%, 75%, or 100% surrounded by the catalyst particles 32. In addition to passing signals through the thickness of the catalyst bed 30, signals received and transmitted by each sensor node 26 and other components of the sensor system 14 are required to pass through a thickness 42 of wall 46 of the vessel 12. The vessel 12 may be manufactured from metallic materials (e.g., steel) that may attenuate the wireless RF signals transmitted by the sensor node 26 and undesirably impact the accuracy and/or precision of sensor measurements within the vessel 12. However, as discussed in further detail below, by converting the RF signals into acoustic signals within the vessel 12, the wireless sensing system 14 may use transmit data (e.g., measured parameter data) through the wall 46. In certain embodiments, the vessel 12 may be manufactured from non-metallic materials, such as plastics, refractory materials, composites, or any other suitable material.

As discussed in further detail below, each sensor node 26 includes circuitry that facilitates measurement of conditions within the vessel 12 and the catalyst bed 30. For example, each sensor node 26 may include an antenna, receiver, transmitter, and other communication components that facilitate wireless communication (e.g., receiving and transmitting signals) with other components of the wireless sensor system 14. For example, each sensor node 26 wirelessly communicates with a through-wall communications system 48 having an internal module 50 disposed, or otherwise coupled to, on an interior surface 52 of the wall 46 and an external module 54 disposed, or otherwise coupled to, an exterior surface 56 of the wall 46. Each catalyst bed 30 may have multiple through-wall communications systems 48 associated with it. For example, each catalyst bed 30 may have 2, 3, 4, 5, or more through-wall communication systems 48 surrounding each respective catalyst bed 30 and spaced apart along the circumferential axis 22. Additionally, the through-wall communications system 48 may be arranged such that each system 48 associated with a respective catalyst bed 30 is at the same or different heights along the axial axis 16 of the vessel 12. That is, the through-wall communications systems 48 may be in an aligned or staggered configuration around (e.g., in the circumferential direction 22) the respective catalyst bed 30.

The modules 50, 54 communicate with one another to provide communication and power signals to one or more sensor nodes 26 and act as intermediaries that allow data and information obtained by the sensor node 26 to be wirelessly transmitted to an external control system 60. The modules 50, 54 include one or more transducers, circuitry, and other components that facilitate wireless transmission of signals to and from the sensor nodes 26 through the thickness 42 of the wall 46.

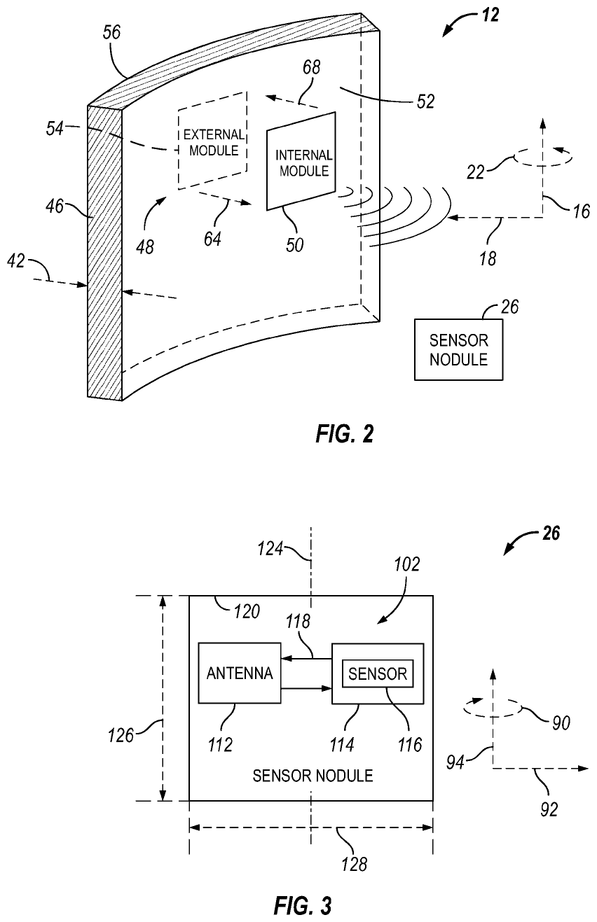

FIG. 2 is an exploded view of a portion of the vessel 12 that illustrates the through-wall communication system 48. As shown in the illustrated embodiment, the internal module 50 and the external module 54 are positioned across from one another and radially 22 aligned on respective surfaces 52, 56 of the wall 46. The internal module 50 may include features that modulate and convert signals received at one frequency into a signal having a different frequency. For example, the internal module 50 may convert a first acoustic signal 64 received from the external module 54 into an electromagnetic signal (e.g., RF signal) that is wirelessly transmitted to the sensor node 26. Similarly, the internal module 50 may modulate and convert electromagnetic signals received from the sensor node 26 into a second acoustic signal 68 containing sensed parameter or condition data and sensor location information. By converting the signals from acoustic to electromagnetic and vice versa, data and information from internal and external components of the wireless sensing system 14 may be wirelessly transmitted through the thickness of the catalyst bed 30 and the wall 46 of the vessel 12 with minimal to no signal attenuation and impact to accuracy and reliability of measurements. In this way, parameters and conditions within the vessel 12 may be monitored and profiled with a desired accuracy and reliability at any location throughout the catalyst bed 30.

The external module 54 communicates with the internal module 50 via the acoustic signals 64, 68 and acts as an intermediary between the control system 60 and the internal components (e.g., the internal module 50 and the sensor nodes 26) of the wireless sensing system 14. Collectively, the modules 50, 46 enable wireless communication between the sensor nodes 26 and the control system 60, as discussed in further detail below. The external module 54 may include one or more transducers arranged in such a manner to efficiently transmit acoustic energy through the wall 34 and to the internal module 50, while not exceeding the threshold for scattering within the wall 34. Circuity and other components, in addition to the transducers, may also form part of the external module 46 to facilitate communication between the various components of the wireless sensor system 14. In embodiments in which the external module 46 includes multiple transducers, the transducers may be arranged in a cluster such that each transducer is positioned on the exterior surface 56 partly or entirely across from the internal module 50. Each transducer in the cluster communicates with the internal module 50. While in the illustrated embodiment, a single through-wall communications system 48 having a single pair of modules 50, 54 are shown, multiple through-wall communications systems 48 may be distributed at various locations around each catalyst bed 30, as discussed above. The number through-wall communications systems 48 may be the same for each catalyst bed 30 or different. For example, in one embodiment, one catalyst bed 30 may have, 4 through-wall communications systems 48 circumferentially 22 surrounding it, and a different catalyst bed 30 within the vessel 12 may have 6 through-wall communication systems 48 circumferentially surrounding it.

In operation, data collected, in real-time, from the sensor nodes 26 may be used to determine parameters and profile conditions within the vessel 12. For example, returning to FIG. 1,the sensor nodes 26 transmit RF signals containing data associated with a sensed parameter or condition and sensor location that is received as low, acoustic, frequencies by the control system 60, via the through-wall communication systems 48. The control system 60 may receive data signals 70 via a wireless or wired connection. In certain embodiments, the control system 60 is located in a remote location that is separate from the plant or where the vessel 10 is located. In one embodiment, the data signals 70 may be stored in cloud and the control system 60 may retrieve the data signals 70 from the cloud to process and profile parameters and/or conditions within the vessel 12. Additionally, the control system 60 may transmit a signal 72 to the through-wall communications system 48. The signal 72 may prompt the external module 54 to provide an acoustic power signal or communication signal to the internal module 50. In certain embodiments, the signal 72 may include instructions to measure parameters or conditions, provide power to the sensor nodes 26, and provide sensor node location signals. To facilitate communication between the control system 60 and the through-wall communications systems 48, the control system 60 may include a transceiver/receiver 74. The transceiver/receiver 74 may transmit the signal 72 and receive the data signals 70 for processing.

The data signals 70 may include a plurality of measurements (e.g., temperature, pressure, reactant concentration, product composition, etc.) associated with the operation of the system 10 and/or performance of the catalyst particles 24. The control system 60 includes a data processing system 76 may use the data to determine, in real-time, reaction conditions and/or environment conditions within the vessel 12 among other things such as sensor position. The data processing system 76 having a microprocessor (μP) 78, memory 80, storage 82, and/or display 84. The memory 80 may include one or more tangible, non-transitory, machine readable media collectively storing one or more sets of instructions for operating the system 10, determining system and reaction parameters, determining reaction and/or environmental conditions, and/or profiling reaction and/or environmental conditions within the vessel 12. In certain embodiments, the one or more sets of instructions may instruct the system 10 to adjust feed rates, temperature, pressure, or any other parameter that may impact the composition of reaction products, catalyst performance, and safe operation of the system 10. For example, in certain embodiments, the control system 60 includes a feedback control element that may receive instructions to automatically adjust reactant concentration or feed rate. The feedback control element may send a signal to one or more valves that control a flow of the reactants/feed.

The memory 80 may include instructions to determine and profile reaction conditions and/or environmental conditions within the vessel 12, and any other information that may be used to determine system parameters during operation as well as provide actionable guidance/recommendations regarding adjusting parameters such as, but not limited to, feed rates, temperature, and pressure based on the measured parameters. Additionally, the memory 80 may include instructions for retrieving the data signals 70 and/or other system information from the cloud. The memory 80 may also store instructions to generate a visualization on the display 84 for an operator of the system 10. Visualizations include, but are not limited to, plots, data confidence levels, alerts, recommendations, measurements, images, and system parameters among others.

To process the data signals 70, the processor 78 may execute instructions stored in the memory 80 and/or storage 82. For example, the instructions may cause the processor 78 to determine reaction parameters (i.e., reaction temperature, pressure, or product composition), changes in the reaction parameters, and determine a profile of the reaction conditions throughout the volume of the vessel 12. In this way, hot/cold spot areas within the reactor may be easily identified and catalyst performance in each respective catalyst bed 30 may be determined.

In addition to monitoring and/or profiling parameters/conditions within the vessel 12, the control system 60 also determines a location of the sensor nodes 26. For example, the control system 60 may transmit an interrogation signal (e.g., the signal 72) instructing the sensor node 26 to transmit a response signal (e.g., the data signal 70). The control system 60 receives the response signal and determines the location of the sensor nodes 26 via any suitable technique. For example, the memory 80 may provide instructions to the processor 78 to determine the location of the sensor nodes 26 within the vessel 12 via time of arrival (ToA), angle of arrival (AoA), time difference of arrival (TDoA), and combinations thereof. For example, when using the ToA technique, the processor 78 may determine a distance between the sensor node 26 and the internal module 50 based on the time it takes for the response signal transmitted from the sensor node 26 to reach the internal module 50. In addition, the control system 60 may determine a location of the sensor nodes 26 by combination of response signals from multiple through-wall communications systems 48.

### Sensor Node

As discussed above, the sensor nodes 26 measure reaction conditions and wirelessly transmit an RF signal having measurement and/or location data to the internal module 50. FIG. 3 is a block diagram of the sensor node 26. The sensor node 26 may have an axial axis or direction 90, a radial axis or direction 92 away from axis 90, and a circumferential axis or direction 94 around the axis 90. The sensor node 26 includes a housing or shell 100 that encloses or otherwise encapsulates internal components of the sensor node 26 and protects or isolates them from the surrounding environment within the vessel in which they are disposed. The shell 100 may be made from any material suitable for withstanding the environment within the vessel and is transparent to the communications frequency in use. For example, the shell 100 may be made of metals or metal alloys, polymers, composites, refractories, glass, ceramic, or any other material suitable for the conditions within the vessel, and combinations thereof. In one embodiment, the shell 100 is alumina. The shell 100 may be a single continuous piece (e.g., a 3D printed shell) or multiple pieces. For example, in one embodiment, the shell 100 includes multiple separate pieces (e.g., 2, 3, 4, or more) connected, or otherwise coupled, to one another, thereby creating a sealed housing and blocking fluids and other materials within the vessel from entering into a cavity 102. The multiple pieces of the shell 100 may be coupled to one another using any suitable coupling technique. For example, the pieces may be coupled to one another by way of adhesives, fasteners, screws, arc or laser welding, or any other suitable coupling technique. The pieces may include a step, lip, or threading so as to ensure alignment and seal. The coupling and sealing may be achieved by combination of one or more methods, and may include one or more materials such as adhesives based upon sintered silver, nickel, gold, or gold-tin or other alloys, alumina, silica, and may include nanoparticulates, preforms, slurries embedded in aqueous or non-aqueous solutions, and organic binder. In some embodiments, it may be preferable that an interface between the multiple pieces of the shell 100 be a metal-metal interface, metal-ceramic interface, glass-metal interface, or glass-ceramic interface. In one preferred embodiment, the two halves of densified alumina (e.g., hemispheres or cylinder and plate) may be laser welded. In doing so, the edge of the ceramics may be coated with metals or alloys suitable for ceramic adherence and joining via laser welding such as molybdenum, manganese, Kovar, copper, silver, gold, so as to ensure hermeticity of the package in the harsh environment. In one embodiment, the shell pieces may be separable. This may enable access to the cavity 102 of the sensor nodes 26 to assemble, replace and/or refurbish internal components (e.g., antenna, sensor circuitry, power devices, etc.). However, in other embodiments, the shell pieces are inseparable. In certain embodiments, a catalyst may be placed within the cavity 102.

In one embodiment, the shell 100 may have an overcoat. For example, in embodiments in which the shell 100 has multiple pieces, the overcoat may provide a seal around the entirety of the shell 100. The overcoat may block exposure of coupling means (e.g., adhesive, fasteners, screws, or the like) to the contents of the vessel. This may mitigate fouling of fasteners, screws, bolts and/or leeching of adhesives that may contaminate vessel contents and/or impact system performance. The overcoat may be any suitable material that does not impede signal transmission from the sensor node 26 to other components of the wireless sensing system (e.g., the wireless sensing system 14), and is durable in the environment within the vessel (e.g., elevated temperatures and pressure, corrosivity, etc.). By way of non-limiting example, the overcoat may include polymeric materials, composites, glass, ceramics, refractories, or any other suitable material. In one embodiment, the overcoat is an alumina-based material.

Within the cavity 102, the sensor node 26 includes sensor circuitry such as an antenna 112 and a plate 114. The plate 114 is a printed circuit board and holds electronics along with other sensor components that facilitate measurement of reaction parameters and conditions (e.g., temperature, pressure, etc.) within the vessel. For example, the plate 114 may support a sensor 116. The sensor 116 may be based upon a piezoelectric resonator technology such as a tuning fork, crystal, or planar interdigitated sensor like a surface acoustic wave (SAW) sensor. In terms of circuit components, the sensor may include inductors (L), capacitors (C), and resistors such as an LC or RLC resonant sensor, purely analogue or digitally electronic or other suitable sensor that may measure reaction parameters and conditions within the vessel. The sensor elements may include piezoelectric materials such as quartz, Langasite, Langatite, or other materials such as silicon carbide (SiC), gallium nitride (GaN), or aluminum nitride (AlN). Using piezoelectric resonators for sensing allows the sensing and communication to be based upon a single device when implementing modulated backscatter. In addition, high accuracy is maintained over extended periods due to the precision of the narrowband resonance and the low drift of highly pure substrate. The plate 114 may be a ceramic or a metallized plate. Non-limiting examples of materials suitable for the plate 114 include alumina, silica, aluminum nitride, silicon carbide, copper, aluminum, nickel or iron-nickel alloy, gold, and combinations thereof. However, any other material suitable for supporting sensor circuitry may be used for the plate 114. The plate 114 is operatively connected to and provides an RF signal 118 to the antenna 112 containing information representative of the measured parameter or condition surrounding the sensor node 26. The function of the plate 114 may also include mechanical support, electrical grounding, or act as a balun for the antenna. The RF signal 118 may also contain information about a location of the sensor node 26 within the vessel (e.g., the vessel 12).

As discussed above, the sensor 116 transmits the RF signal 118 to the antenna 112. The antenna 112 receives and wirelessly transmits the RF signal 118 to the internal module (e.g., the internal module 50) for further processing. In addition, the antenna 112 wirelessly receives an RF signal from the internal module that may be used to provide power to the sensor node 26 and facilitate determining its location within the vessel. Performance of antennas generally decrease when they are smaller than one wavelength at the operating frequency. Therefore, to minimize loss in performance, the antenna 112 may be shaped in a manner that maximizes its overall electrical length within the size constraints of the sensor node 26. By having the longest electrical length possible under the size constraints of the shell 100, the resonant frequency of the RF signal may be lowered. The antennas 112 used in the sensor nodes 26 due to the small physical size of the shell 100 and operation at low RF frequency (low MHz) are considered electrically small antennas which generally have high impedance mismatch, low efficiency, and narrow frequency bandwidth. The overall radiation performance of an electrically small antenna is a function of the antenna's occupied physical volume. An approach to design efficient electrically small antennas is to bend wires into a desired shape within a fixed occupied volume. The overall length of the wire will be adjusted to maintain a resonance frequency at a desired operating frequency. The self-resonance nature of such antenna provides better impedance matching and higher efficiency features. The overall length of the wire can be adjusted by the number of turns, radius and height of the coil depending on the shape of structure. The radius and height of the coil is recommended to be maximized with respect to the volume to achieve a higher radiation efficiency. By way of non-limiting example, the length of the antenna 112 is between approximately 2 and 64 centimeters (cm).

The shape of the antenna 112 is selected such that uniform pressure and stress are applied to the least amount of volume possible on the antenna 112. This shape may conform to a shape of the cavity 102 and/or the shell 100. By way of non-limiting example, the shape of the antenna 112 may be spherical, cylindrical, cubic, rectangular, or any other shape that provides maximum performance and fits within the cavity 102 of the sensor node 26. The antenna 112 may have a curved or helical configuration. In certain embodiments, the antenna 112 extends throughout the cavity 102 in both the axial direction 90 and the radial direction 94 such that it is adjacent to an inner wall 120 of the shell 100, and occupies a portion of the volume within the cavity 102. In one embodiment, the antenna 112 surrounds (e.g., circumferentially 94) the entirety of the plate 114. That is, the antenna 112 may form a cage around the plate 114. In other embodiments, the antenna 112 surrounds only a portion of the plate 114.

As discussed above, the antenna 112 may have a curved or helical configuration. That is, the antenna 112 is coiled into the desired shape within the cavity 102. The electrical length of the antenna 112 may be adjusted by the number of turns in the coil. A radius of each turn (i.e., curve) in the coiled configuration of the antenna 112 is maximized with respect to the volume. For example, the radius of each turn in the coiled configuration may be approximately equal to the radius of the cavity 102. The antenna 112 may have an omnidirectional radiation pattern, radiating equal power in all directions perpendicular to a central axis 124 of the antenna 112. In certain embodiments, the antenna 112 is tuned to be capacitive, thereby reducing electrical connections and complexity of the sensor node 26. In other embodiments, the antenna 112 includes a ferrite loaded antenna coil so as to reduce the physical size when operating at the lower RF frequency range.

The sensor node 26 may be any shape and size depending on system design and configuration in which it will be used to sense parameters. As discussed above, performance of the antenna 112 decreases with size. As such, the size of the sensor node 26 is determined by the size of the antenna 112, which is selected based on internal communications frequency that minimizes losses in the media within the vessel. As the sensor 116 transmits the RF signal 118 containing data and information on measured parameters/conditions and/or location, the internal communications frequency selected is also driven by RF propagation characteristics within the vessel. In addition, the wireless sensing system 14 described herein provides real-time sensor localization integral with the communications waveform, which simplifies design while reducing parts count compared to systems having parallel sensing and geolocation systems. In preferred embodiments, transmission within the vessel 12 occurs at frequencies where the electromagnetic plane wave modes dominate (i.e., at high frequencies such as those greater than or equal to 5 MHz), so that sensor node localization is achieved by use of coherent pattern matching, implemented with machine learning techniques. Therefore, the shape and size of the sensor node 26 may be determined based on the configuration of the antenna 112 that provides the best performance at the desired internal communications frequency. By way of non-limiting example, the sensor node 26 may be spherical cubic, cylindrical, rectangular, polygonal, or any other suitable shape. The sensor node 26 may be sized to match a particle size of the catalyst particles (e.g., the catalyst particles 32) that make up the catalyst bed (e.g., the catalyst bed 30). That is, each sensor node 26 may have dimensions that are substantially equal to dimensions for the catalyst particles in the catalyst bed. For example, the sensor node 26 has a first dimension 126 (e.g., an axial dimension, a first diameter) and a second dimension 128 (e.g., radial dimension, a second diameter) that is substantially orthogonal to the first dimension. In the illustrated embodiment, the dimensions 126, 128 are substantially the same. However, in other embodiments, the dimensions 126, 128 are different. In certain embodiments, the first dimension 126 may vary along the radial direction 92 and/or the second dimension 128 may vary along the axial direction 90. For example, in instances in which the shape of the sensor node 26 is polygonal. The dimensions 126, 128 may be in a range from approximately 5 millimeters (mm) to approximately 30 mm or more depending on system design and vessel media.

### Through-Wall Communications System

### INTERNAL MODULE

As discussed above, with reference to FIG. 2, the sensor node 26 wirelessly communicates with the internal module 50, via RF signals, to provide sensed parameters/conditions within the vessel 12 and its location information. The internal module 50 provides RF power and communication signals to the sensor node 26. In addition, the internal module 50 communicates, via acoustic signals, with the external module 54 to transmit and receive sensed data and power, respectively. As discussed above, the internal module 50 acts as an intermediary between internal components (e.g., the sensor node 26) and external components (e.g., the external module 54) of the wireless sensor system (e.g., the wireless sensor system 14). The internal module 50 may modify and convert acoustic signals from the external module 54 that pass through the wall 46 into electromagnetic signals (e.g., RF signals) used to wirelessly communicate with the sensor node 26. Accordingly, the internal module 50 includes multiple features that facilitate communication with both the sensor node 26 and the external module 54.

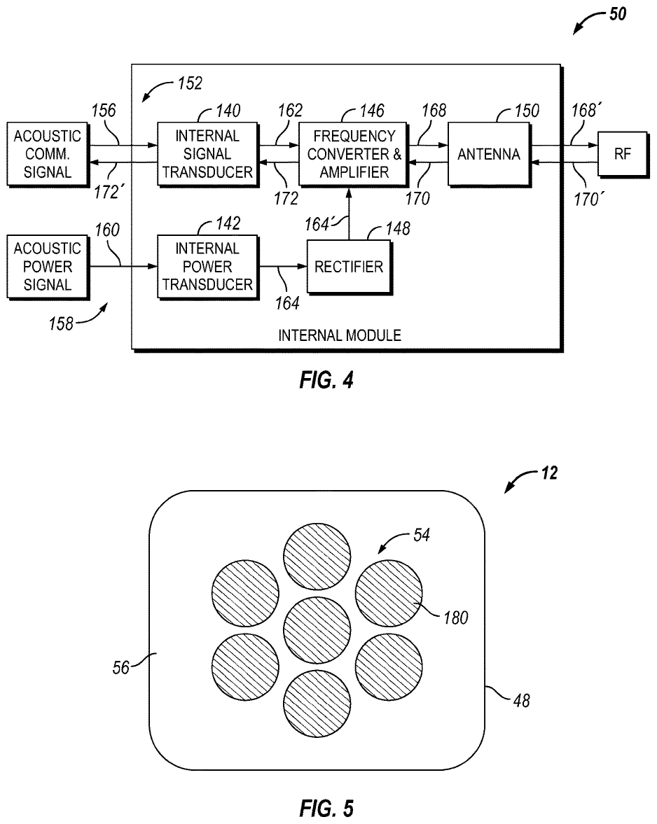

FIG. 4 is a block diagram of the internal module 50 that forms part of a through-wall communications systems (e.g., the through-wall communications system 48) of the wireless sensor system disclosed herein. In the illustrated embodiment, the internal module 50 may be a circuit that includes an internal signal transducer 140, an internal power transducer 142, a frequency converter and amplifier 146, a rectifier 148, and an antenna 150. The RF antenna 150 transmits and receives signals to and from the sensor nodes (e.g., the sensor nodes 26). By way of non-limiting example, the antenna 150 may be a dipole, a patch or a quarter wave patch (QWP), an Inverted-F antenna (IFA) or Planar Inverted-F antenna (PIFA) antenna or any other suitable antenna that facilitates transfer of an RF signal 162 to one or more sensor nodes (e.g., the sensor nodes 26) within the vessel.

Communication between components of the through-wall communications system may occur through one or more signal channels. The signal channels provide a pathway for the acoustic signals transmitted through the wall of the vessels to communicate with the components of the internal module 50. For example, in the illustrated embodiment, the internal signal transducer 140 is part of a first signal channel 152 that provides a path for an acoustic communication signal 156 to communicate between the internal module 50 and the external module (e.g., the external module 54). This acoustic communication signal 156 may contain instructions from a control system (e.g., the control system 60) that instruct the sensor node to measure a parameter or conditions within the vessel. The acoustic communication signal 156 may also instruct the sensor node to provide location and/or power information. In one embodiment, the acoustic communication signal 156 may be an interrogation signal that triggers a response signal from the sensor node to ensure that the sensor node is properly working. The first channel 152 may be a high frequency channel (e.g., frequency of at least 5 megahertz (MHz)). In certain embodiments, the first channel 152 may operate at a frequency that is substantially the same as the RF transmission frequency between the internal module 50 and the sensor nodes within the vessel. Similarly, the internal power transducer 142 is part of a second channel 158 that provides a pathway for an acoustic power signal 160 to communicate between internal module 50 and the external module. In certain embodiments, the sensor nodes within the vessel do not contain a battery or other similar power source. The acoustic power signal 160 is used to wirelessly provide power to the sensor nodes. The second channel 158 may operate at a frequency that is different from the first channel 158. In certain embodiments, the second channel 158 operates at a low frequency (e.g., a frequency less than approximately 5 MHz). It should be noted that, other embodiments of the present disclosure include using a single channel to for the signals 156, 160 rather than the separate channels 152, 158.

The transducers 140, 142 facilitate communication with the external module and convert the acoustic signals 156, 160 into electrical signals that are used to communicate with the sensor nodes. The transducers 140, 142 may be any suitable transducer that converts acoustic energy into electrical energy. In one embodiment, the transducers 140, 142 are piezoelectric transducers. Due to the harsh environment within the vessel (e.g., elevated temperatures and pressure) the transducers 140, 142 are selected from materials that are robust and suitable for the harsh environment. For example, in embodiments in which the transducers 140, 142 are piezoelectric transducers, the piezoelectric materials are selected from high temperature piezoelectric materials that maintain their piezoelectric properties at temperatures above 200 °C and retains a low electrical conductivity at high temperatures to efficiently transmit acoustic power across the wall of the vessel. Examples of piezoelectric materials may include, but are not limited to, piezoelectric ceramics or single crystals such as barium titanate, langasite, langatite, lithium niobate, among others. In addition to the high temperature and electromechanical charge coefficient, other characteristics of suitable piezoelectric materials include good mechanical and thermal stability and ability to be coupled to the vessel wall.

As discussed above, the internal module 50 converts acoustic signals into RF signals within the vessel. The frequency converter and amplifier 146 may be used to convert electric communication signal 162 and electric power signal 164 into RF signal 168, and RF data signal 170 into an acoustic data signal 172. Prior to converting the electric power signal 164 in the frequency converter and amplifier 146, the rectifier 148 may convert the signal 146 from a two-directional alternating current (AC) to a single-directional direct current (DC), thereby generating a DC power signal 164′. The internal module 50 may also include one or more transmit/receive switches and one or more amplifiers (e.g., a low noise amplifier and/or power amplifier) to facilitate conversion and amplification of the signals 162, 164′, 170. For example, each of the transducers 140, 142 and the RF antenna 150 may include respective transmit and receive switches to select between a “query” or “response path. For example, in the “query” path, the signals 162, 164′ are converted into RF signal 168, which is transmitted by the antenna 150 to the sensor node via RF signal 168′. In the “response” path, the RF data signal 170 is converted into the acoustic data signal 172 and transmitted to the external module via acoustic data signal 172′.

In one embodiment, in the “query” path, a frequency of the signal 156 may be at 10 MHz during transmission through a wall of the vessel (e.g., the wall 46) and is converted to a frequency of 50 MHz (e.g., the RF signal 168, 168′) used for communicating with the sensor node. Conversely, in the “response” path the frequency of the RF data signal 170, 170′ may be converted from 50 MHz to 10 MHz, which transmits the acoustic data signal 172′ containing information (e.g., measured parameters/conditions, sensor location, etc.) from the sensor node to the external module. The “query” and “response” paths may operate one at a time and in opposite directions within the same channel (e.g., the first channel 152) to enable wireless communication between the sensor nodes (e.g., the sensor node 26) and wireless sensing system components located external to the vessel (e.g., the external module 54 and/or the control system 60). Before converting the signals 156, 160, 162, 164′, 170, these signals may be amplified. For example, the signal 156, 160, 162, 164′, 170 may be amplified from a few millivolts (mV) peak-to-peak to approximately 1 volt (V) peak-to-peak. Similarly, after conversion, the converted signal (e.g., signals 168, 172) may be amplified to drive the RF antenna 150 or the transducer 140, respectively.

The signals 156, 160, and the signal 170, may be converted from acoustic to RF and RF to acoustic, respectively, using any suitable frequency conversion technique. In certain embodiments, the frequency of the signals 156, 160, 170 may be converted using a frequency mixing technique. In this technique, the frequency of the signal 156, 160, 170 is shifted by multiplying this signal with another signal that is at a different frequency. For example, if the frequency of the signal 156, 160, 170 is at 10 MHz, multiplying it with a signal at 40 MHz creates 30 and 50 MHz signals. Depending on the desired frequency, either the 30 or 50 MHz signal is filtered out to create the desired frequency shifted signal. Another technique that may be used to convert the frequency of the signals 156, 160, 170 is a harmonic conversion process. In this technique, harmonics of the signal 156, 160, 170 are created which are further processed to create a signal at the desired frequency. Therefore, by converting the frequency of the signals 156, 160, 170 the wireless sensing system of the present disclosure may wirelessly transmit data and power signals through the wall of the vessel, and use RF signals to measure conditions and parameters within the vessel.

The internal module 50 is non-removably coupled, or otherwise fixed, to an interior wall (e.g., the wall 52) of the vessel. Specifically, the internal module 50 is coupled to an interior surface of the vessel that is adjacent to and/or abutting/contacting media (e.g., the catalyst bed 30/catalyst particles 32) within the vessel. Air gaps/pockets between the interior surface of the vessel and the internal module 50 may attenuate or otherwise impact transmission of the signal 156, 160, 172′ through the wall (e.g., the wall 46) of the vessel. Accordingly, in certain embodiments, a coupling agent may be used to bond, or otherwise couple, the internal module 50 to the interior surface of the vessel. The coupling agent may fill in any air gaps/pockets that may be present at the interface between the internal module 50 and the interior surface. The coupling agent may include high temperature materials that do not deteriorate or become compromised in the extreme/harsh conditions, such as those that may be present within the vessel (e.g., temperatures above 200 °C and pressures up to 21 megapascals (MPa)) In addition, differences in coefficients of thermal expansion between the materials used to fabricate the internal module 50 (e.g., the piezoelectric material) and the vessel (e.g., steel, refractory, etc.) may cause mechanical stress. Therefore, it is desirable for the coupling agent to include materials that are tolerant to these stresses. Moreover, it is also desirable for the coupling agent to include materials that provide a low-reflection, low-attenuation transmission path for the signals 156, 160, 172′. By way of non-limiting example, suitable coupling agents may include silver foil, sintered silver paste, nickel-based adhesives, among others. In certain embodiment, brazing and/or welding may be used to couple the internal module 50 to the wall of the vessel.

In one embodiment, the internal module 50 may include a first portion that is non-removably coupled to the interior wall of the reactor as discussed above, and second portion that is removable. For example, the internal module 50 may include a base or plate that is non-removably coupled to the interior wall of the vessel. The transducers 140, 142, the frequency converter and amplifier 146, the rectifier 148, an antenna 150, or combinations thereof are removably coupled to the base. As such, any one of these components may be easily removed should they require maintenance or replacement.

### External Module

As discussed above, the internal module 50 communicates with an external module (e.g., the external module 54) to wirelessly transmit data and receive power through a vessel wall (e.g., the wall 46) via acoustic signals (e.g., the signals 156, 160, 172′). FIG. 5 is a diagram of illustrating a portion of the vessel 12 having the external module 54 that may be used to transmit and receive acoustic signals (e.g., the signals 156, 160, 172′) through the wall 48. The external module 56 includes a plurality of transducers 180. In certain embodiments, the external module 56 has a single transducer 180. In the illustrated embodiment, the transducers 180 are arranged in a cluster configuration or array. However, the transducers 180 may be arranged in any other suitable configuration such as side-by-side, staggered, block, or any other configurations that facilitates wireless communication between the external module 54 and the internal module.

The transducers 180 may be attached to the exterior surface 56 of the vessel 12 in a manner similar to internal modules (e.g., the internal module 50). For example, the transducers 180 may be bolted, screwed, adhered, brazed, welded, or otherwise coupled to the exterior surface 56. In one embodiment, the transducers 180 are each attached and secured to a plate (e.g., a metallic plate), which is coupled to the exterior surface 56. By securing the transducers 180 onto a plate, each of the transducers 180 may be positioned/arranged on the plate in a manner that achieves efficient transmission of a desired power concentration across a thickness of the wall 48. The plate may be attached to the exterior surface 56 via any suitable coupling means, for example, screws, bolts, fasteners, adhesives, welding, and the like. A coupling agent may be used to attach the transducers 180 to the exterior surface 56 or plate and/or the plate to the exterior surface 56 similar to the internal module. The coupling agent may fill in any air gaps/pockets between the transducers 180, the plate, or both and the exterior surface 56.

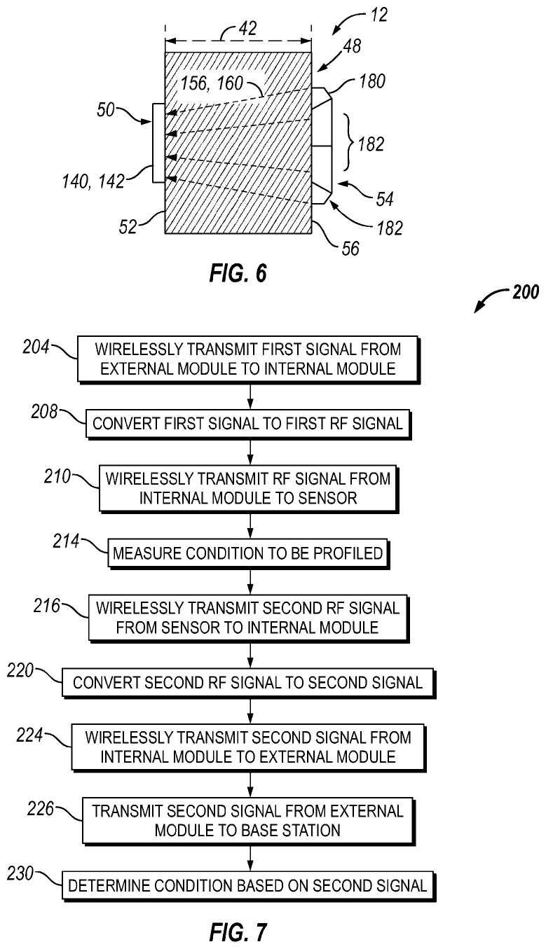

The transducers 180 may transmit signals (e.g., the signals 154, 160) through the wall 48 at the same or different frequency. For example, in one embodiment, a portion of the transducers 180 may transmit a signal at a frequency of between approximately 100 kHz and 5 MHz and another portion of the transducers 180 may transmit a signal at a frequency of between approximately 5 MHz and 20 MHz. However, in other embodiments, each transducer 180 in the external module 54 transmits the same frequency through the wall 48. In embodiments in which the external module 54 includes an array of transducers 180, these transducers may be low-frequency transducers (e.g., 250 kilohertz (kHz)) that each transmit a respective acoustic signal 156, 160 to a single transducer of the internal module, as shown in FIG. 6. In embodiments in which the external module 54 includes a single transducer 180, this transducer transmits a high frequency acoustic signal 156, 160 (e.g., less than 1 MHz) that maintains a tight beam of transmitted acoustic energy as it goes through the wall 48 without exceeding a threshold for scattering within the wall 48. By way of non-limiting example, the transducers 180 may be lead zirconate titanate or any other suitable piezoelectric material. As the transducers 180 are not exposed to the harsh environment within the vessel 12, unlike the internal module, the piezoelectric materials are not required to operate at temperatures in excess of 100 °C.

To ensure efficient power transfer through the wall 48, the transducers 180 are impedance matched to the transducers in the internal module. Efficient delivery of acoustic power signals (e.g., the acoustic power signal 160) to the internal module will facilitate wirelessly powering the sensor nodes within the catalyst bed and avoid the use of batteries for powering the sensor nodes. As such, the vessel 12 does not require decommissioning to replace sensor nodes and/or sensor nodes batteries. For example, in embodiments in which the external module 54 includes a single transducer 180, a frequency of the acoustic power signal may be approximately 1 MHz. This frequency is sufficient to provide a desired beam of acoustic energy through the wall 48 without undesirable attenuation. In embodiments having multiple transducers 180, the frequency of the signal may be less than 1 MHz depending on the number and arrangement of the transducers 180. For example, turning to FIG. 6, the transducers 180 are arranged on the exterior surface 56 in an array in a manner that each of the transducers 180 are pointing toward a single transducer 140, 142 of the internal module 50. The exterior surface 56 may be curved. As such, the transducers 180 are arranged in a manner that array conforms to the curved exterior surface 56. For example, a first portion 182 of the transducers 180 may lay flat on the exterior surface 56 while another portion 184 of the transducers 180 may be angled, giving the array of transducers 180 a disk-like (or satellite) configuration. A coupling agent may be used to fill in any air gaps/pockets as discussed above. Arranging the transducers 180 in this manner provides a desirable transmission efficiency in spite of using lower frequency (e.g., a frequency of less than 500 kHz). This arrangement also provides the desired power transmission across the thickness 42 of the wall 48.

The external module 54 may communicate with a control system (e.g., the control system 60) via a wired or wireless connection. The transducers 180 may receive signals from the control system to trigger communication with the sensor nodes. The external module 54 also provides response signals from the sensor node to the control system containing information about sensed parameters or conditions within the vessel, sensor location, power level, etc.

In certain embodiment, the wireless sensing system disclosed herein does not include the external module 54. In this particular embodiment, the internal module 50 may be connected directly to the control system via a wired connection. Accordingly, the internal module may not need to convert acoustic signals to RF signals and vice versa. Therefore, the transducers, converter and amplifier, and rectifier may be omitted from the internal module 50. For example, the control system may provide an RF communication signal to the antenna of the internal module. This RF communication signal is wirelessly transmitted to the sensor nodes 26. In response to the RF communication signal, the sensor nodes 26 wirelessly transmit an RF data signal to the internal module that is subsequently transmitted to the control system. In certain embodiments, the frequency of the RF communication signal and the RF data signal is the same. However, in other embodiments, the frequency of the RF communication signal and the RF data signal is different. For example, the RF communication signal may be at a higher frequency than the RF data signal or vice versa.

Embodiments of the present disclosure also include a method for wirelessly monitoring and/or profiling parameters and/or conditions within a vessel under harsh or extreme environments. FIG. 7 is a block flow diagram of a method 200 that may be use the wireless sensing system (e.g., the wireless sensing system 14) disclosed herein to monitor and/or profile parameters and conditions within a vessel. The method 200 includes transmitting a first signal from an external module to an internal module (block 204). For example, as discussed above, the external module (e.g., the external module 54) includes transducers (e.g., transducers 180) that wirelessly transmit an acoustic signal (e.g., the acoustic signal 156, 160) through a thickness (e.g., the thickness 42) of a wall (e.g., the wall 48) of a vessel (e.g., the vessel 12). The acoustic signal is received by a transducer (e.g., the transducers 140, 142) of an internal module (e.g., the internal module 50) disposed within the vessel and enters a “query” path that enables communication with a sensor node (e.g., the sensor node 26).

The method 200 also includes converting the first signal to a first RF signal (block 208). Once received, the transducers of the internal module convert the first signal into an electrical signal (e.g., the signal 162, 164) that is provided to converter (e.g., the frequency converter and amplifier 146). The converter modifies the electrical signal by changing its frequency and converting it into the RF signal (e.g., the RF signal 168). The converter may also amplify the signal.

Following conversion of the first signal to the first RF signal, the method 200 includes transmitting the first RF signal from the internal module to the sensor (block 210). For example, as discussed above, the internal module includes an antenna (e.g., the antenna 150) that receives the first RF signal and wirelessly transmits the first RF signal to the sensor node. The first RF signal triggers the sensor node to measure a desired parameter or condition to be profiled within the vessel (block 214). For example, the sensor node may measure a temperature, pressure, and/or pH. The sensor node may also measure feed and/or effluent composition such as, for example, concentrations of reactants, products, byproducts, contaminants, etc. In certain embodiments, the first RF signal may provide power to the sensor node.

The method 200 also includes wirelessly transmitting a second RF signal from the sensor node to the internal module (block 216). The second RF signal (e.g., the RF data signal 170) contains information (e.g., data) about the parameters or conditions to be profiled, location, and/or power level.

Similar to the first signal, the second RF signal is converted into a second signal (block 220) in the internal module. For example, the antenna of the internal module receives the second RF signal and transmits it to the converter via a “response” path. The converter modifies the second RF signal by changing its frequency and converting it into an acoustic second signal (e.g., the acoustic data signal 172). The converter may also amplify the second signal before transmitting it through the wall of the vessel and to the external module (block 224).

The method 200 also includes wirelessly transmitting the second signal from the external module to a base station (block 226) and determining a condition based on the second signal (block 230). As discussed above, a control system (e.g., the control system 60) receives the acoustic data signal 70, 172 containing information about the sensed parameters and/or conditions, sensor node location, and other information. The control system processes the information to determine and/or profile the sensed parameters and gain insight about processes occurring within the vessel. For example, the control system may profile temperature or pressure over time. This may facilitate determining reaction kinetics and catalyst performance, among other things.

The technical effects of the wireless sensing system disclosed herein facilitates monitoring and profiling process conditions within vessels (e.g., reactors), in particular in harsh or extreme environments. For example, the wireless sensing system includes multiple sensor nodes dispersed within a medium contained within the vessel. The sensor nodes use RF signals to measure parameters and/or conditions within the vessel that are indicative of reaction kinetics and/or catalyst performance. The RF signals contain localized data associated with the sensed parameters/conditions at or near a “field of view” of the sensor nodes. These RF signals are transmitted wirelessly from the each of the sensor nodes to an internal module within the vessel via RF data signals. Because the sensor nodes are dispersed throughout a volume of the vessel and communicate wirelessly with the internal module, the sensor nodes provide information about parameters/conditions throughout the entirety of the media contained within the vessel. Certain existing sensors used in harsh or extreme environments are generally wired and unable to provide information across the entire volume of the media within a vessel. These sensors are generally confined to locations near vessel walls where wires that lead to external system components are located. While wireless sensors exist, these sensors are unable to transmit wireless signals through vessels walls, in particular metallic vessel walls, without signal attenuation. However, the disclosed wireless sensing system uses a combination of acoustic and RF signals to provide wireless communication between the sensor nodes and components located outside of the vessel (e.g., the control system). For example, the internal module receives the RF signal from the sensor nodes and coverts the RF signal to an acoustic signal that is wirelessly transmitted to an external module (and consequently the control system) located outside of the vessel. The internal module also converts acoustic signals wirelessly received from the external module to RF communication signals that facilitate communication with the control system and sensor nodes. The RF communication signals provide information that trigger the sensor nodes to provide localized data about parameters/conditions within the vessel. In addition, the control system may provide acoustic power signals that are converted in the internal module to RF power signals that provide power to the sensor nodes. In this way, the wireless sensing system of the present disclosure provides an effective, efficient, and robust technique for profiling parameters/conditions in extreme or harsh environments within a vessel wirelessly.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

1. A system, comprising:
a vessel having a wall defining a volume, wherein the vessel is configured to contain media;
a wireless sensing system comprising:
a plurality of sensor nodes dispersed within the media and configured to measure one or more parameters or conditions within the vessel and to wirelessly transmit a first data signal containing the one or more parameters/conditions; and
one or more through-wall communications systems attached to the wall of the vessel and configured to wirelessly communicate with the plurality of sensor nodes, to transmit a first communication signal, a first power signal, or both through the wall of the vessel, to receive the first data signal, and to transmit a second data signal through the wall of the vessel; and
a control system communicatively coupled to the wireless sensing system and configured to determine and profile the one or more parameters/conditions based on the second data signal.

2. The system of claim 1, wherein each through-wall communications system of the one or more through-wall communications systems comprises an internal module attached to an interior surface of the wall of the vessel, wherein the internal module comprises an antenna configured to wirelessly transmit a second communication signal, a second power signal, or both to one or more sensor nodes of the plurality of sensor nodes and to wirelessly receive the first data signal.

3. The system of claim 2, wherein the internal module comprises a first transducer, a second transducer, and a frequency and amplitude converter, wherein the first transducer is configured to wirelessly receive the first communication signal, the second transducer is configured to wirelessly receive the first power signal, and the frequency and amplitude converter is configured to convert the first communication signal into a second communication signal and the first power signal into a second power signal, and wherein the first communication signal and the first power signal are acoustic signals and the second communication signal and the second power signal are electromagnetic signals.

4. The system of claim 3, wherein the frequency and amplitude converter is configured to convert the first data signal into the second data signal, wherein the first transducer is configured to wirelessly transmit the second data signal through the wall of the vessel, and wherein the first data signal is an electromagnetic signal and the second data signal is an acoustic signal.

5. The system of claim 3, wherein each through-wall communications system of the one or more through-wall communications systems comprises an external module attached to an exterior surface of the wall of the vessel, wherein the external module comprises one or more transducers configured to wirelessly transmit the first communication signal and the power signal through the wall of the vessel and to the internal module.

6. The system of claim 5, wherein the external module comprises a cluster of transducers, wherein each transducer in the cluster of transducers is configured to wirelessly transmit the first communication signal or the first power signal to the first transducer or the second transducer, respectively.

7. The system of claim 6, wherein the cluster of transducers are arranged in a manner that creates constructive interference when focusing multiple signals into one signal between transducers.

8. The system of claim 2, wherein each sensor node of the plurality of sensor nodes comprises a housing defining a cavity, the cavity containing a sensor and an antenna, and wherein the antenna is configured to wirelessly receive the second communication signal and the second power signal, and to wirelessly transmit the first data signal.

9. The system of claim 8, wherein the antenna is helical, or coils around the sensor.

10. The system of claim 8, wherein the housing does not attenuate electromagnetic signals

11. The system of claim 1, wherein the first communication signal and the first power signal have a frequency different from the first data signal.

12. The system of claim 1, wherein a frequency of the first communication signal and the first data signal is the same.

13. The system of claim 1, wherein the vessel comprises one or more catalyst beds comprising the media, and wherein the media is a plurality of catalyst particles.

14. The system of claim 1, wherein the one or more parameters or conditions are selected from pressure, temperature, chemical composition, vapor and liquid composition, density, flow rate, pH, vibration, radiation, magnetic flux, light intensity, and sound intensity.

15. The system of claim 1, wherein the control system is configured to monitor a change in signal strength and attenuation from one or more sensor nodes of the plurality of sensor nodes.

16. A method for monitoring and profiling conditions within a vessel using a wireless sensing system, comprising the steps of:
transmitting a first signal to a through-wall communications systems attached to a wall of the vessel, wherein the through-wall communications system is configured to wirelessly communicate with one or more sensor nodes dispersed with media contained in the vessel;
transmitting a second signal, wirelessly, from the through-wall communications system in response to the first signal to the one or more sensor nodes, wherein the one or more sensor nodes comprises an antenna configured to receive the second signal;
measuring one or more parameters associated with a condition to be profiled in response to the second signal, wherein the sensor node comprises a sensor configured to measure the one or more parameters in response to the second signal and generated a first data signal;
transmitting the first data signal containing information associated with the one or more parameters measured, a location of the one or more sensor nodes, or both to the through-wall communications systems, wherein the first data signal is an electromagnetic signal; and
determining and profiling, using a processor, the condition within the vessel based on the first data signal, wherein the processor is part of a control system communicatively coupled to the wireless sensing system.

17. The method of claim 16, comprising converting the frequency of the first signal into the frequency of the second signal in an internal module forming part of the through-wall communications system and attached to an interior surface of the wall, wherein the internal module comprises at least one transducer, a frequency converter and amplifier, and an antenna, wherein the frequency of the first signal is in the acoustic range and the frequency of the second signal is in the electromagnetic range, and wherein the first signal is wirelessly transmitted through the wall of the vessel.

18. The method of claim 17, comprising converting the first data signal into a second data signal in the frequency converter and amplifier, wirelessly transmitting the second data signal through the wall of the vessel and to an external module of the through-wall communications systems attached to an exterior surface of the wall, and transmitting the second data signal to the control system, wherein the second data signal is an acoustic signal and contains the information associated with the one or more parameters measured, the location of the one or more sensor nodes, or both.

19. The method of claim 18, wherein the external module comprises one or more transducers configured to receive and wirelessly transmit the first signal through the wall and to the at least one transducer of the internal module, and configured to receive and transmit the second data signal to the control system.

20. The method of claim 19, wherein the external module comprises a cluster of transducers arranged in a disc-like shape, wherein each transducer in the cluster of transducers is configured to wirelessly transmit the first signal to a single transducer in the internal module.

21. The method of claim 16, comprising wirelessly providing power to the one or more sensor nodes via an electromagnetic power signal transmitted by the through-wall communications systems.

22. The method of claim 21, comprising converting an acoustic power signal transmitted through the wall of the vessel into the electromagnetic power signal before providing the power to the one or more sensor nodes.

23. The method of claim 16, wherein a frequency of the first signal is different from that of the second signal.

24. The method of claim 16, wherein the frequency of the first signal and the second signal is the same.
